(19) United States
(12) Patent Application Publication
(10) Pub. No.: US 2025/0347216 A1
(43) Pub. Date: Nov. 13, 2025

(54) AUTOMATIC FIBER CABLE IDENTIFICATION AND CALIBRATION FOR WELL SYSTEMS

(71) Applicant: Halliburton Energy Services, Inc., Houston, TX (US)

(72) Inventors: Henry Bland, Calgary (CA); Mikko K. Jaaskelainen, Houston, TX (US)

(21) Appl. No.: 18/657,246

(22) Filed: May 7, 2024

(51) Int. Cl. E21B 47/09; E21B 43/26; E21B 47/01; E21B 47/135; E21B 49/00; G01V 1/22; G01V 1/28; G01V 13/00; G02B 6/26

(52) U.S. Cl. CPC E21B 47/09; E21B 47/01; E21B 49/00; G01V 1/226; G01V 1/288; G01V 13/00; E21B 43/2607; E21B 47/135; G02B 6/266

(57) ABSTRACT

Systems, methods, and apparatus, including computer programs encoded on computer-readable media, for implementing an optical marker for fiber optic cable identification and well system calibration and automation. A well system may include a fiber optic cable and an optical marker device. The optical marker device may include a fiber optic line configured to couple to the fiber optic cable of the well system. The optical marker device may include one or more attenuators coupled with the fiber optic line. The one or more attenuators are configurable to set an optical marker that uniquely identifies the fiber optic cable. The optical marker device that implements the optical marker may be positioned at a known location of the well system for use in the calibration and automation of the well system.

### TECHNICAL FIELD

The present invention relates generally to oil and gas systems and services, and more specifically to automatic fiber cable identification and calibration for well systems.

### BACKGROUND

In the oil and gas services industry, it is typically a challenge to deploy optical fibers and enable automation at well sites. Fiber optic cables can be manufactured with some form of identifier that is manually entered into the various tracking systems, sensing systems, data collection engines, data processing engines and data visualization engines. However, it is common that names of wells or fiber cable identifiers are mismatched during one or more steps in the manual process thus resulting in costly errors. Also, multiple sensing cables may be connected to a data collection center, where multiple fiber optic interrogators and cables are connected, and thus it is not uncommon for a cable to be connected to the wrong interrogator, which can also result in costly errors. Typically, there is no simple technique of optically verifying that a specific cable is connected to the right interrogator, if the cable is labeled wrong, or the information is typed in wrong in one or multiple points in the system, during the equipment preparation, transport to the field, deployment, and connection to the interrogation system, among others.

Another challenge in the oil and gas services industry is fiber depth calibration. Typically, a Distributed Acoustic Sensing (DAS) system is connected to the fiber cable, and then a tap test is performed manually to determine the actual correlation between the position along the fiber and well depth. To carry out a tap test, a field technician approaches the cable at the wellhead and mechanically taps on the cable as it exits the wellhead. In some cases, the tap test is difficult or impossible to perform as the wellheads are often located in dangerous areas with high-pressure pipes. Thus, it can be problematic to gain access to perform a tap test. Furthermore, a tap test can have a broad acoustic signature that propagates along the cable, which can result in inaccurate results. After performing the tap test, a second person (e.g., a DAS system operator who is not at the wellhead) may then manually analyze several data collection traces around the time the first person performed the tap test in order to locate the tap test in the historical recordings. The fiber calibration process using the tap test is prone to various errors in terms of associating the fibers, wells, data acquisition, event detection, data management, data modeling, data visualization, and other systematic errors.

### BRIEF DESCRIPTION OF THE DRAWINGS

FIG. 1 depicts a schematic diagram of an example well system including an optical marker device that is configurable to set an optical marker for identifying a fiber optic cable, according to some implementations.

FIG. 2 depicts a schematic diagram of an example optical marker device including an optical fiber line and attenuators, according to some implementations.

FIG. 3 depicts a schematic diagram of another example optical marker device including an optical fiber line and attenuators, according to some implementations.

FIGS. 4A-4C depict schematic diagrams of an example optical marker device setting an optical marker for the fiber optic cable, according to some implementations.

FIG. 5 depicts a schematic diagram of an example well system including an optical marker device configured to set an optical marker for identifying a fiber optic cable and for system calibration and data collection automation, according to some implementations.

FIG. 6 is a flowchart of example operations for implementing a configurable optical marker for a fiber optic cable of a well system, according to some implementations.

FIG. 7 is a schematic diagram of an example well system that implements a configurable optical marker for uniquely identifying the fiber optic cable, according to some implementations.

### DESCRIPTION

The description that follows includes example systems, methods, techniques, and program flows that describe aspects of the disclosure. However, it is understood that this disclosure may be practiced without these specific details. For instance, this disclosure refers to certain well systems, devices, or tools in illustrative examples. Aspects of this disclosure can be instead applied to other types of well systems, devices, and tools. In other instances, well-known instruction instances, protocols, structures, and techniques have not been shown in detail to avoid confusion.

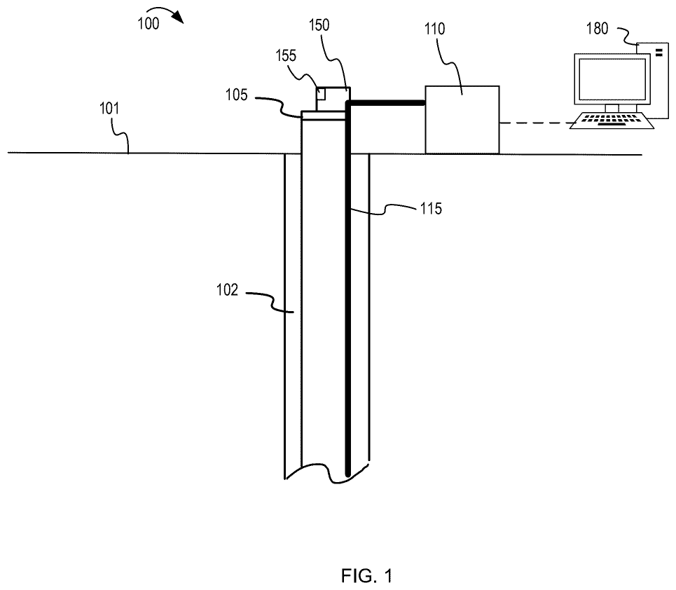

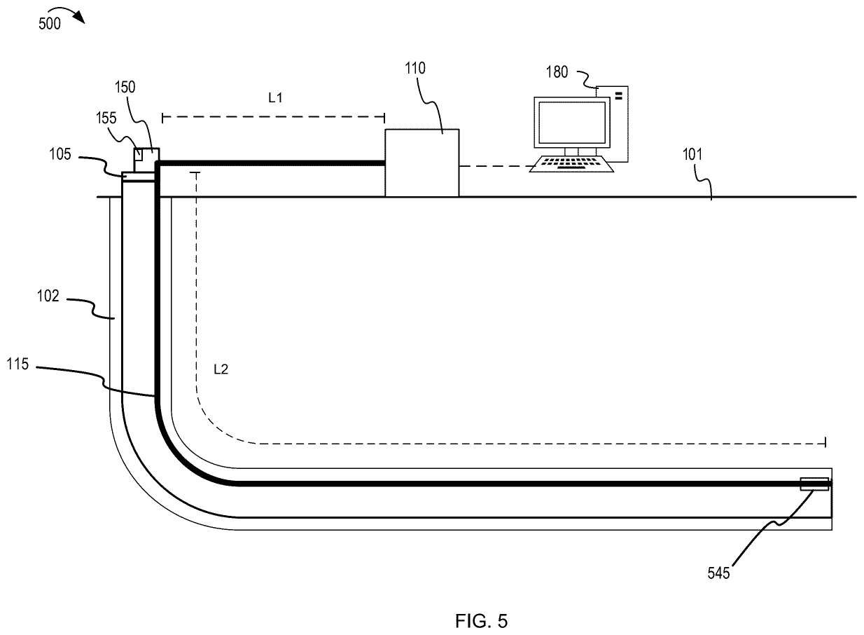

FIG. 1 depicts a schematic diagram of an example well system 100 including an optical marker device 150 that is configurable to set an optical marker for identifying a fiber optic cable, according to some implementations. In some implementations, the well system 100 may include a wellbore 102, a wellhead 105, distributed acoustic sensing (DAS) interrogator 110, a fiber optic cable 115, the optical marker device 150, and a computer system 180. The optical marker device 150 may also be referred to as an optical marker tool, module, assembly, or box, or an optical identifier device, tool, module, assembly, or box. It is noted that the well system 100 may include additional devices, tools and other components that are not shown for simplicity. In some implementations, the fiber optic cable 115 may be deployed downhole in the well. For example, the fiber optic cable 115 may be deployed in various ways, such as by using a fiber optic deployment tool, as further described in FIG. 5. In some implementations, the fiber optic cable 115 may be temporarily deployed and may be removable from the well. In some implementations, the fiber optic cable 115 may be permanently installed in the well. The fiber optic cable 115 may be connected at the opposite end to well equipment, such as the DAS interrogator 110. In some implementations, before or after deployment of the fiber optic cable 115, the optical marker device 150 may be connected to the fiber optic cable 115 at a known location or position. For example, as shown in FIG. 1, the optical marker device 150 may be connected to the fiber optic cable 115 at the wellhead 105. It is noted, however, that in other implementations the optical marker device 150 can be connected to other points in the fiber optic cable 115. In some implementations, the optical marker device 150 may be configurable to set an optical marker or optical identifier for the fiber optic cable 115 to uniquely identify the fiber optic cable 115 and distinguish the fiber optic cable 115 from other fiber optic cables in the same or different well systems, as further described below. The optical marker or identifier may be referred to as a configurable optical marker or identifier. Also, in some implementations, the optical marker device 150 and/or the fiber optical cable 115 may include a human-readable label 155 that can also be used to uniquely identify the fiber optic cable 115, as further described below. Furthermore, in some implementations, the well system 100 may utilize the configurable optical marker and the known location of the optical marker device 150 to calibrate the fiber optic cable 115 and the computer systems of the well system 100 to implement automation for well data collection, as further described in FIG. 5.

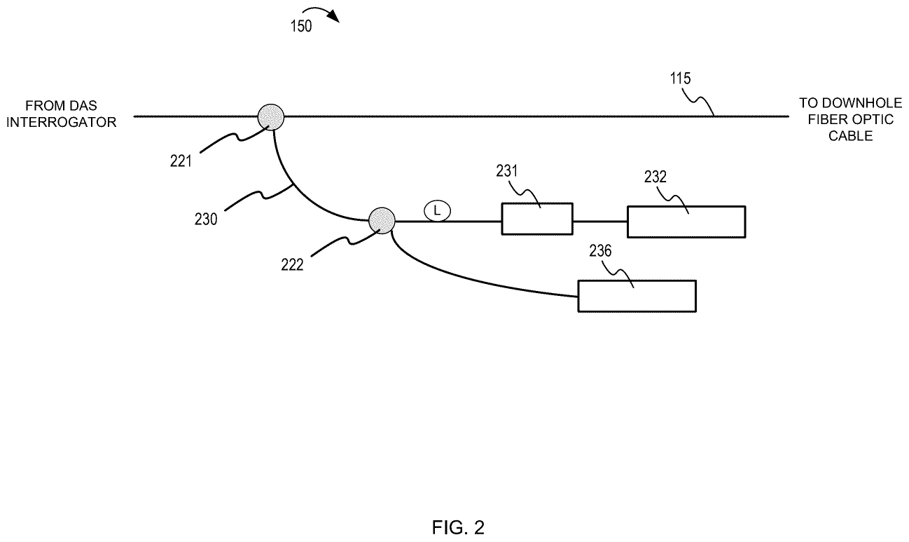

In some implementations, the optical marker device 150 may include an optical fiber line and one or more attenuators. The attenuators may be configurable to set the optical marker or optical identifier for the fiber optic cable 115 to uniquely identify the fiber optic cable 115. The optical fiber line may be connected to the fiber optic cable 115, and the one or more attenuators may be connected to the fiber optic line. For example, the fiber optic line may be connected to the fiber optic cable 115 via a first fiber optic coupler, and the one or more attenuators may be connected to one or more fiber optic stub lines that split off from the fiber optic line of the optical marker device 150 via a second fiber optic coupler, as further described in FIGS. 2-4C. It is noted that the fiber optic line, fiber optic couplers, and the attenuators of the optical marker device 150 may have a variety of configurations, as described further below in FIGS. 2-4C. Since the fiber optic line of the optical marker device 150 splits off from the fiber optic cable 115, an optical signal that is transmitted via the fiber optic cable 115 can also be received by the optical marker device 150. In some implementations, the one or more attenuators may be configurable to attenuate received optical signals, such that the reflections from the optical signals have a signal signature that can serve as an optical marker or identifier. For example, the one or more attenuators may vary the amplitude of the reflected optical signals and the variations in the amplitude can serve as the optical marker or identifier, as further described in FIGS. 2-4C. The optical marker or identifier can uniquely identify the fiber optic cable 115 to any devices that connect to the fiber optic cable 115, such as the DAS interrogator 110, other surface well equipment or computer systems (such as computer system 180), and handheld devices, among others.

In some implementations, the attenuators may be electrical or mechanical optical attenuators, such as variable optical attenuators (VOAs), and the attenuation levels of the attenuators may be configured or programmed by a programming device. For example, the programming device can be an external device or tool that connects to the optical marker device 150 to configure or program the attenuators (e.g., VOAs) using software. The optical marker or identifier may be non-volatile, such that the optical encoding remains even when the electrical power is removed from the optical marker device 150. In some implementations, the attenuators may be mechanical attenuators, and the attenuation levels of the attenuators may be configured or set mechanically. For example, the optical marker device 150 may have one or more mechanical mechanisms, such as knobs, buttons, or any other type of mechanism to configure or set the mechanical attenuators.

In some implementations, the human-readable label 155 may be located or positioned on the outside of the optical marker device 150 (e.g., on the outside of the housing or container of the optical marker device 150) to be readable by personnel at the well site. In some implementations, the human-readable label 155 may be positioned or deployed at any point or section of the fiber optic cable 115. The human-readable label 155 may also be positioned on both the optical marker device 150 and on the optical fiber cable 115. The human-readable label 155 may be non-volatile. For example, the human-readable label 155 may be an e-ink label or display, which will preserve the label without requiring continuous electrical power and can be read under direct sunlight. The human-readable label 155 and the optical marker device 150 being non-volatile may be ideally suited for deployment in field locations where the presence of powered electronic devices is limited or not allowed.

Both the optical marker and the human-readable label 155 can be set during fiber optic deployment. Once set (e.g., using the programming device), both the optical marker and the human-readable label can remain set without requiring any electrical supply. In some implementations, since the optical marker and the human-readable label 155 both uniquely identify the fiber optic cable 115, the optical marker and the human-readable label 155 are linked, and this information may be stored in a database (e.g., such as a local database like computer system 180 and/or a remote database) so that any device which reads the optical marker or identifier can also retrieve details about the fiber optic cable 115 (e.g., deployment well, depth of deployment, and kind of fiber, among others). For example, the optical marker, the human-readable label 155 and the optical fiber cable 115 can be linked, related, or associated in the database using a look-up table. For example, the look-up table may indicate that a reflected optical signal (or multiple reflected optical signals) with a certain signal signature is linked to certain fiber optic cable (such as fiber optic cable 115) and a certain human-readable label 155. In some implementations, the programming of the optical marker device 150 may also include tying in the optical marker data with a unique RFID tag or barcode.

In some implementations, a database (which may be implemented in computer system 180 and/or other local or remote systems) may store the cross-reference between the human-readable label 155 and the optical marker or identifier. The database may be accessed and updated via a wired or wireless link, using either dedicated hardware, a smart device such as a phone, or a computer terminal. In some implementations, during a pre-job programming process, unique names may be allocated and tied to a given RFID tag, a bar code, the human-readable label 155, and the optical marker. Each of these identifiers, or a subset of these identifiers, may be tracked during system planning, load-out, deployment in the field to a specific well, connection with a fiber optic interrogator unit (e.g., such as DAS interrogator 110) and data collection. In some implementations, the computer system 180 may automatically initiate the fiber optic sensing system to identify the optical marker with a known distance to the start of the sensing fiber, identify the end of the optical fiber, and then automatically calibrate the fiber optic system and implement automation for data acquisition, as further described in FIG. 5.

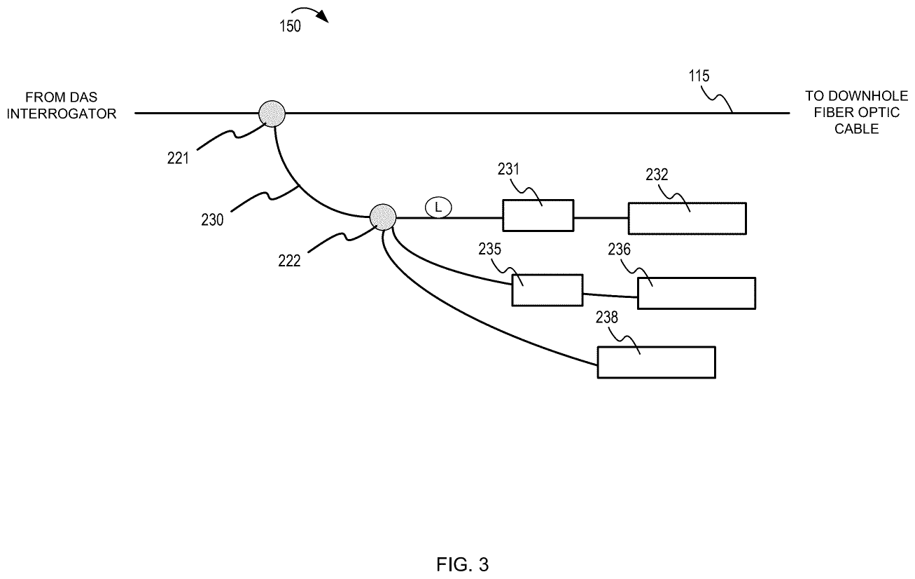

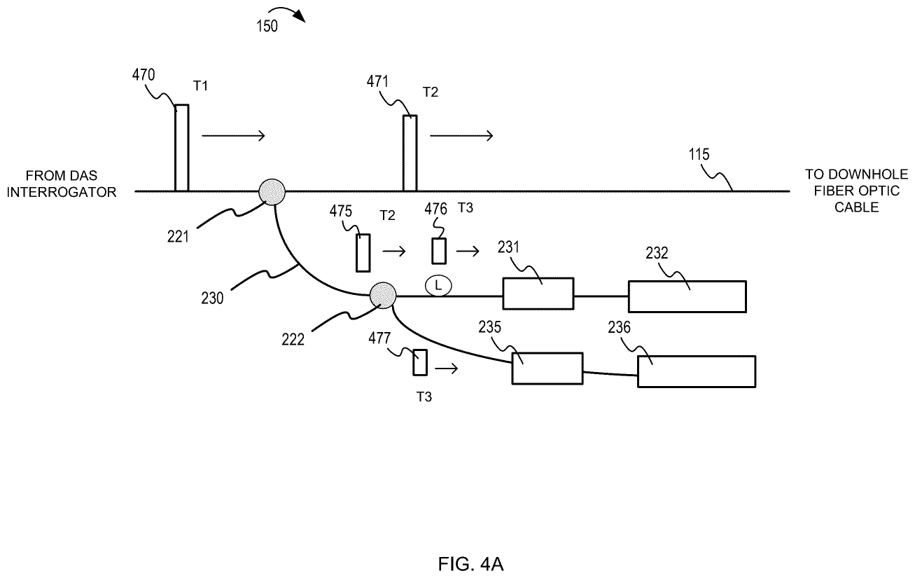

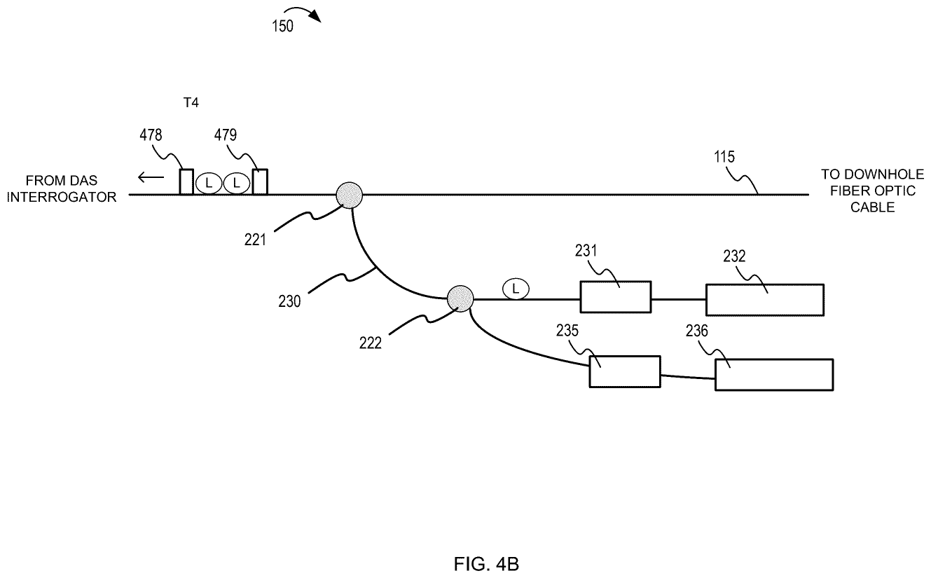

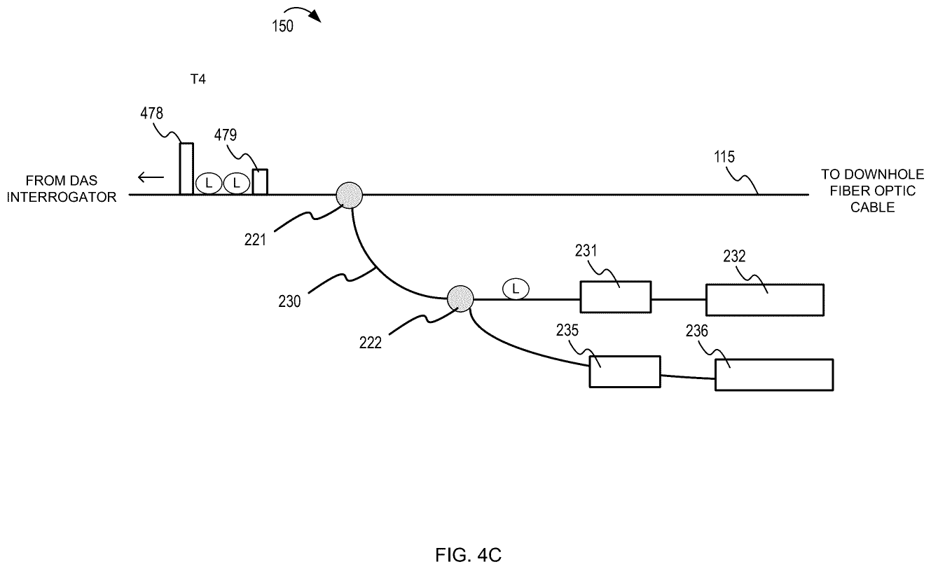

FIG. 2 depicts a schematic diagram of an example optical marker device 150 including an optical fiber line and attenuators, according to some implementations. As shown in FIG. 2, in some implementations, the optical marker device 150 may include a fiber optic line 230 having two fiber optic stub lines, a first fiber optic coupler 221, a second fiber optic coupler 222, a first attenuator 231, a first reflector 232, and a second reflector 236. The first stub path may include the first attenuator 231 and the first reflector 232, and the second stub path may include the second reflector 236. As described in FIG. 1, the first attenuator 231 may be a passive device and may be a programmable VOA or a configurable mechanical attenuator. The setting or programming of the first attenuator 231 can set and determine the optical marker or identifier for the fiber optic cable 115. For example, the setting or programming of the first attenuator 231 can determine the signal signatures, such as the amplitude of the reflected optical signal (e.g., reflected from the first reflector 232). In this example, the detected amplitude characteristics can serve as the optical marker or identifier for the fiber optic cable 115. Furthermore, the amplitude of the optical signal may be controlled by the coupler split ratio, and the spacing between the optical signals may be controlled by the difference in length of the optical fiber between the two stub paths, as further described in FIGS. 4A-4C. The difference in length between the first stub path and the second stub path is represented by length “L” in FIG. 2. The second stub path may be a reference path to compare the reflected signal from the first stub path, since the amplitude of the reference path may be a known amplitude. The reflected signal from the second stub path may be reflected from the second reflector 236. Based on the above, the optical marker device having the stub paths, attenuators, and reflectors provides a backscattering optical path for the optical signal, and thus the optical path reflection amplitude can be used for the optical marker. The optical marker device 150 may have various configurations, which may include more than two fiber optic stub lines and two or more attenuators, as shown in FIG. 3.

FIG. 3 depicts a schematic diagram of another example optical marker device 150 including an optical fiber line and attenuators, according to some implementations. As shown in FIG. 3, in some implementations, the optical marker device 150 may include a fiber optic line 230 having three fiber optic stub lines, a first fiber optic coupler 221, a second fiber optic coupler 222, a first attenuator 231, a first reflector 232, a second attenuator 235, a second reflector 236, and a third reflector 238. It is noted that in other implementations the optical marker device 150 may include any number of stub paths, attenuators, and reflectors. The first stub path may include the first attenuator 231 and the first reflector 232, and the second stub path may include the second attenuator 235 and the second reflector 236. The first attenuator 231 and the second attenuator 235 may be passive devices and may be programmable VOAs or configurable mechanical attenuators. The setting or programming of both the first attenuator 231 and the second attenuator 235 can set and determine the optical marker or identifier for the fiber optic cable 115. For example, the setting or programming of the first attenuator 231 and the second attenuator 235 can determine the signal signatures, such as the amplitude of the reflected optical signal from the first stub path (e.g., reflected from the first reflector 232) and the amplitude of the reflected optical signal from the second stub path (e.g. reflected from the second reflector 236). The detected amplitude received from both the first stub path having the first attenuator 231 and the second stub path having the second attenuator 235 can serve as the optical marker or identifier for the fiber optic cable 115. Furthermore, the amplitude of the optical signal may be controlled by the coupler split ratio, and the spacing between the optical signals may be controlled by the difference in length of the optical fiber between the two stub paths, as further described in FIGS. 4A-4C. The difference in length between the first stub path and the second stub path is represented by length “L” in FIG. 3. The third stub path may be a reference path to compare the reflected signal from the first and second stub paths. The reflected signal from the third stub path may be reflected from the third reflector 238.

FIGS. 4A-4C depict schematic diagrams of an example optical marker device 150 setting an optical marker for the fiber optic cable 115, according to some implementations. In some implementations, as shown in FIG. 4A, the optical marker device 150 may include a fiber optic line 230 having at least two fiber optic stub lines, a first fiber optic coupler 221, a second fiber optic coupler 222, a first attenuator 231, a first reflector 232, a second attenuator 235, and a second reflector 236. Although not shown for simplicity, the optical marker device 150 may also include a third stub path (e.g., a reference path) with a third reflector, similar to FIG. 3. Additional stub paths and reflectors could also be included in the optical marker device 150. In some implementations, an optical signal (e.g., such as a laser pulse 470) may be transmitted via the fiber optic cable 115 at time T1. For example, the DAS interrogator 110 or other well equipment may transmit the optical signal via the fiber optic cable 115. The first fiber optic coupler 221 of the optical marker device 150 can split the laser pulse 470 according to the coupler's split ratio. For example, the coupler's split ratio may be between 90/10 and 99.9/0.1. As one example, when the split ratio is 90/10, 90% of the laser pulse continues downhole via the fiber optic cable 115 at time T2 (e.g., laser pulse 471) and 10% of the laser pulse is received by the fiber optical line 230 of the optical marker device 150 at T2 (e.g., laser pulse 475). The laser pulse 475 is split again by the second fiber optic coupler 222 based on the coupler's split ratio before the signal propagates into the stub paths. For example, the split ratio of the second fiber optic coupler may be between 10/90 and 90/10. As one example, the coupler's split ratio may be 50/50, and the laser pulse 475 can be split evenly between the two stub paths, such that the laser pulse 476 propagates through the first stub path to the first attenuator 231 and the laser pulse 477 propagates through the second stub path to the second attenuator 235 at time T3. In some implementations, the first stub path may include an extra length “L” of line or a coil that serves to delay the laser pulse 476 before it reaches the first attenuator 231. After the laser pulse 476 is reflected (e.g., by reflector 232), the laser pulse 476 travels through the delay line or coil a second time. The laser pulse 477 propagates through the second stub path without the two “L” delays from the delay line or coil, and thus the reflected laser pulse 477 is 2×L ahead of the reflected laser pulse 476. In other words, the reflected laser pulse 476 is separated from the reflected laser pulse 477 by 2×L, as further described in FIG. 4B.

FIG. 4B depicts the two reflected pulses at time T4 separated by the delay introduced by the delay line or coil (e.g., 2×L). For example, laser pulse 478 may be the reflected optical signal from the second stub path having the second attenuator 235 and no delay line or coil, and laser pulse 479 may be the reflected optical signal from the first stub path having the first attenuator 231 and the delay line or coil. In this example, since the fiber optic coupler 222 had a 50/50 split ratio and the attenuators 231 and 235 had the same configuration or setting, the amplitudes of the reflected optical signals are equal (or approximately equal with some minimal error). As described above, the optical marker is set by the attenuators 231 and 235 of the optical marker device 150. For example, each attenuator may attenuate the optical signal to one of ten levels of amplitude that can be represented as levels 0-9. In this example, the level may provide one digit to the optical marker. Thus, an optical marker device 150 with two stub paths (not including any reference stub path) and two attenuators may set a two-digit optical marker. An optical marker device 150 with three stub paths and three attenuators may set a three-digit optical marker. Thus, in this example, if the amplitudes of the laser pulses 478 and 479 correspond to an amplitude level of 1, the optical marker device 150 may set a two-digit optical marker of “11” for the fiber optic cable 115. The optical marker can uniquely identify the fiber optic cable 115. If additional digits are needed for the number of distinct fiber optic cables, the optical marker device 150 may include additional stub paths with additional attenuators to set an optical marker with a greater number of digits.

FIG. 4C depicts another example of reflected pulses at time T4 separated by the delay introduced by the delay line or coil (e.g., 2×L). For example, laser pulse 478 may be the reflected optical signal from the second stub path having the second attenuator 235 and no delay line or coil, and laser pulse 479 may be the reflected optical signal from the first stub path having the first attenuator 231 and the delay line or coil. In this example, the attenuators 231 and 235 may have a different configuration or setting, and thus the amplitudes of the reflected optical signals are different. If the amplitude of the laser pulse 478 corresponds to an amplitude level of 7, and the amplitude of the laser pulse 479 corresponds to an amplitude level of 1, the optical marker device 150 may set a two-digit optical marker of “71” for the fiber optic cable 115. The optical marker can uniquely identify the fiber optic cable 115.

In some implementations, the optical marker device 150 shown in FIGS. 1-4C may work with Optical Time Domain Reflectometry (OTDR) based systems, where an optical pulse is transmitted from a fiber optic instrument and back scattered light is measured as a function of time. Some VOAs keep their attenuation setting when disconnected from the electrical power and still be configured or set to perform a pre-planned job. The optical interrogation can be done with normal OTDRs or with DAS systems. Each fiber optic cable that is set with an optical marker (using an optical marker device) is uniquely identified by the amount of attenuation on the attenuated stub. Most OTDRs should be able to easily differentiate at least 10 levels of attenuation, providing 10 unique characteristics of each fiber to be identified. Depending on the system requirements and noise environment, the number of uniquely identifiable levels of attenuation may vary (for instance, 3 levels, or 30 levels). When multiple attenuation stubs are used, the number of unique identifiers is represented by k, where k is the number of uniquely recognizable attenuation levels, and N is the number of stubs fitted with an attenuator. For example, a two-attenuator system with eight uniquely-identifiable attenuation levels would allow for 82=64 unique identifiers. The optical marker can be combined with an RFID tag and/or a programable human-readable non-volatile label.

FIG. 5 depicts a schematic diagram of an example well system 500 including an optical marker device 150 configured to set an optical marker for identifying a fiber optic cable and for system calibration and data collection automation, according to some implementations. Similar to FIG. 1, the well system 500 may include a wellbore 102, a wellhead 105, distributed acoustic sensing (DAS) interrogator 110, a fiber optic cable 115, the optical marker device 150, and a computer system 180. In some implementations, the fiber optic cable 115 may be deployed downhole in the well. For example, the fiber optic cable 115 may be deployed in various ways, such as by using a fiber optic deployment tool (described below). In some implementations, the fiber optic cable 115 may be temporarily deployed and may be removable from the well. In some implementations, the fiber optic cable 115 may be permanently installed in the well. The fiber optic cable 115 may be connected at the opposite end to well equipment, such as the DAS interrogator 110. In some implementations, before or after deployment of the fiber optic cable 115, the optical marker device 150 may be connected to the fiber optic cable 115 at a known location or position. For example, as shown in FIG. 5, the optical marker device 150 may be connected to the fiber optic cable 115 at the wellhead 105. It is noted, however, that in other implementations the optical marker device 150 can be connected to other points in the fiber optic cable 115. As described above in FIGS. 1-4C, the optical marker device 150 may be configured to set an optical marker or optical identifier for the fiber optic cable 115 to uniquely identify the fiber optic cable 115. Furthermore, in some implementations, the well system 100 may utilize the optical marker and the known location of the optical marker device 150 to automatically calibrate (e.g., depth calibrate) the fiber optic cable 115 and the computer systems of the well system 100 and to automate well data collection, as further described below.

In addition to providing a unique identifier to identify the fiber optic cable 115, the optical marker can serve additional functions. In some implementations, the optical marker can be used to calculate the distance between an interrogating fiber optic instrument (such as the DAS interrogator 110 or OTDR instrument) and the position of the optical marker device 150 that sets the optical marker. Often, an unknown length of surface fiber optic cable (shown in FIG. 5 as length L1) connects the DAS interrogator 110 to the wellhead 105. Knowing the length of this surface cable can help to depth calibrate the system, as this surface cable can affect the matching of depth points along the well to the optical sensing channels returned by the DAS interrogator 110. Depth calibration of the system can help in interpreting the readings from an interrogating instrument (such as the DAS interrogator 110) and ensuring that readings from within the well are attributed to the correct portion of the well.

Furthermore, in some implementations, the optical marker device 150 having the optical marker that is positioned at a known location may also be used to determine the deployed fiber length of the fiber optic cable 115 to perform the depth calibration. The deployed fiber length may be represented in FIG. 5 by the length L2. During fiber optic cable deployment, a deployment tool 545 may be used that is released from the surface and pumped down the wellbore 102, and the deployment tool 545 releases the fiber optic cable 115 as it propagates down the wellbore 102. The data acquisition may start when the sensing system is connected to the fiber optic cable 115 and the wellhead location can then be accurately identified using the optical marker device 150. The identification of the deployed fiber length with the wellbore 102 may then be triggered when the fiber deployment process is complete, or by automatically monitoring the deployment, sensing the length of deployed fiber via OTDR, and waiting until the deployment has stopped. In some implementations, the software (e.g., such as software in the DAS interrogator 110 or software in the computer system 180) may automatically identify the interface between the fiber optic cable left in the deployment tool and the fiber optic cable that has been deployed in the well.

In some implementations, a fiber optic sensing system (e.g., such as a handheld detection device (e.g., OTDR handheld scanners), a computer such as computer system 180, or other surface equipment (e.g., the DAS interrogator 110)) may be configured to detect the location of the optical marker device 150 that sets the optical marker for the fiber optic cable 115, and also detect the signal signature of the optical marker that is used to uniquely identify the optical marker. The fiber optic sensing system may also be configured to detect the end of the usable fiber optic cable (which may also be referred to as a fiber, a sensing fiber, sensing cable, or a sensing fiber optic cable), i.e., the end of the sensing fiber for a permanently deployed sensing cable or the end of the sensing fiber deployed in a well, where some length of fiber is left within a deployment tool.

The usable fiber optic cable, or the length of fiber optic cable deployed in the well bore vs. the length of fiber optic cable left in the disposable tool can be identified using, e.g., optical attenuation measurements or strain measurements. The fiber left in the deployment tool is coiled and will incur bend-induced loss that can be measured using, e.g., an Optical Time Domain Reflectometry (OTDR) instrument, where bend induced loss is wavelength dependent. The position along the fiber of this loss can be measurable using OTDRs operating at, e.g., 1625 nm or 1650 nm, among others. The difference in attenuation between the fiber deployed in the wellbore vs. the fiber left in the deployment tool then makes it possible to measure the respective lengths accurately. A person skilled in the art will recognize that various combinations between fiber types, i.e., optical fiber properties, diameter of the fiber coil and OTDR wavelengths can be used. An alternative method of determining these lengths is to observe the strain. A coiled fiber will have some bend-induced strain, where the strain is different from the strain of a fiber deployed in the wellbore. A strain measurement along the fiber allows detection of the interface between the fiber deployed in a wellbore vs. fiber left in the coil in the deployment tool. Yet another alternative for determining the length of deployed fiber is to perform dynamic strain measurement during deployment, where the fiber deployed in the wellbore may experience dynamic strain due to fluid movement and/or deployment tool movement, whereas the fiber in the fiber coil inside the deployment tool would not be exposed to dynamic strain of the same magnitude. A person skilled in the art will recognize that the measurements used for the interface detection may be Rayleigh based or Brillouin based or intensity based or frequency based or interferometric based measurements, or a combination of one or more of these measurement principles.

In some implementations, the process of identification of the fiber lengths may initiate an automatic calibration routine when the interrogation system (e.g., the DAS interrogator 110) is connected to the sensing fiber optic cable 115 and ready to start data acquisition. The calibration may include tuning laser powers, adjusting transmitting optical amplification levels, adjusting receiving optical amplification levels, setting detector levels, and setting the gauge length, among others, as dictated by the sensing application for the best signal-to-noise ratio (SNR). In some implementations, an automatic event detection may then start and run automatically during the job. The data analysis software may be controlled by a supervisory control system that may be connected to a fracturing spread (which may be referred to as frac spread). Data may be locally processed on site or be sent automatically to a remote facility, such as a remote cloud server network, where data from one or multiple wells and well sites may be used to determine formation properties relevant to the control of the hydraulic fracturing operation. This may allow automatic real-time control and/or stage and well level modifications to completions and/or fracturing operations, for example.

In some implementations, a computer system (which may be referred to as a fiber data collection system) may be configured to calibrate a sensing fiber (such as the fiber optic cable 115) for automatic data collection with a DAS system (e.g., the DAS interrogator 110). The data may be used for microseismic monitoring and/or formation strain monitoring. In some implementations, the microseismic and strain data may be used to infer formation properties and/or hydraulic fracture properties relevant to hydraulic fracturing operations. Based on the optical marker and the microseismic and strain data, the system can measure, e.g., how fast fractures arc propagating in both directions and then decide whether and how to control the fracturing pumps. In some implementations, the data collected may be used to control a frac spread connected to a treatment well. The frac spread may use electrical and/or diesel and/or natural gas fracturing pumps. In some implementations, a supervisory control system may use the automatically identified optical marker and information regarding the end of usable sensing fiber (and/or the length of the usable sensing fiber) to automatically calibrate the fiber optic cable 115. The automatically calibrated sensing cable may be used to automatically detect microseismic and/or formation strain events. The automatically detected microseismic and/or formation strain events may be used to automatically infer formation and/or fracture properties related to hydraulic fracturing operations. The supervisory control system may control the frac spread parameters (e.g., which can control the frac pumps) in response to the inferred formation and/or fracture properties. Fracturing pumps may include hydrocarbon fueled pumps or electrical pumps or a combination thereof. Control actions may include changing fluid pump rates, changing pump pressure, change fluid composition by modifying the chemical composition, varying proppant concentration and/or composition or adding diverters. Thus, the implementation of the optical markers can help to uniquely identify fiber optic cables (such as the fiber optic cable 115) and calibrate the well system, which may allow additional automation to be introduced into well systems (such as the well system 500).

In some implementations, as described above in FIGS. 1-5, a combination of a unique, configurable optical marker (which may also be referred to as a unique optical hardware identifier) that can be automatically detected using a fiber optic interrogator, and software and other mechanisms that can recognize the location of the optical marker and identify the optical marker may be used for fiber optic cable identification, system calibration, and system automation. The identity of the optical marker can be tied to the sensing fiber optic cable in a specific well, and the location can be used for automatic fiber calibration. As described above, by adding the optical marker device at a known location, e.g., at the wellhead or at a location with a known distance from the wellhead, the optical marker with a known location can be used to determine the start of the optical fiber optic cable and can also detect the end of the optical fiber cable to allow for automatic depth calibration. Implementing a configurable optical marker to uniquely identify fiber optic cables, calibrate the well system, and automate data collection may simplify the process of fiber deployment, saving money on training and specialized field personnel, and may further automate and simplify the well workflow. It may also, simultaneously, reduce the probability of non-productive-time (NPT) charges caused by field errors. Furthermore, by using a deployment-time, configurable optical marker or identifier, there may not be a need to manufacture fibers ahead of time with non-configurable identifiers.

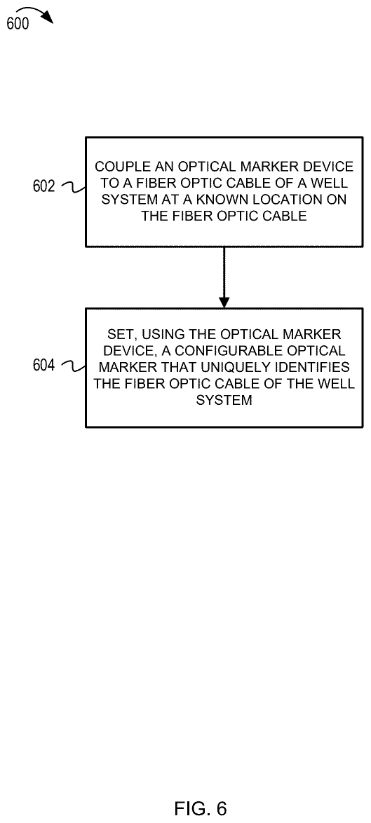

FIG. 6 is a flowchart 600 of example operations for implementing a configurable optical marker for a fiber optic cable of a well system, according to some implementations. In some implementations, an optical marker device may be coupled to the fiber optic cable at a known location on the fiber optic cable (block 602). The configurable optical marker that uniquely identifies the fiber optic cable of the well system may be set using the optical marker device (block 604). In some implementations, the optical marker device may be configured to set the configurable optical marker for the fiber optic cable. In some implementations, one or more attenuators of the optical marker device may be configured to set the configurable optical marker for the fiber optic cable.

In some implementations, in addition to the configurable optical marker, a human-readable label may be set to visually identify the fiber optic cable of the well system. The human-readable label may be located on the optical marker device or on the fiber optic cable. In some implementations, an association between the configurable optical marker, the human-readable label, and the fiber optic cable may be stored in a database. In some implementations, an optical signal may be transmitted via the fiber optic cable of the well system. In some implementations, one or more attenuated and reflected optical signals that are output by the optical marker device may be detected by the well system. In some implementations, the configurable optical marker is determined from the one or more attenuated and reflected optical signals. In some implementations, the fiber optic cable is identified based on the configurable optical marker determined from the one or more attenuated and reflected optical signals.

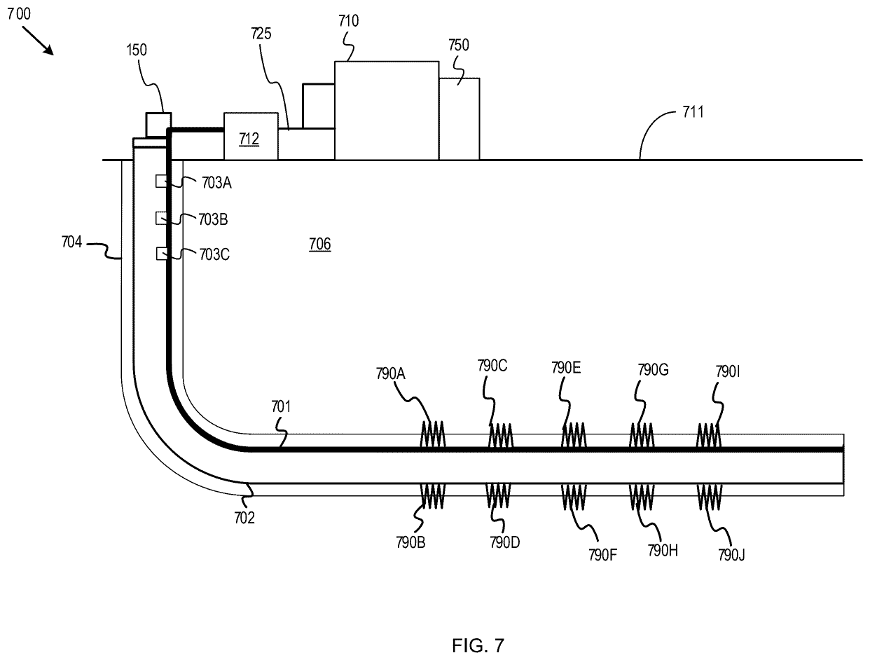

FIG. 7 is a schematic diagram of an example well system that implements a configurable optical marker for uniquely identifying the fiber optic cable, according to some implementations. A well system 700 may comprise a wellbore 704 in a subsurface formation 706. The wellbore 704 may include a casing 702 and a number of perforations 790A-790J being made in the casing 702 at different depths as part of hydraulic fracturing to allow hydraulic communication between the subsurface formation 706 and the casing 702 and to allow fracturing at different zones. The well system 700 may also include an optical marker device 150 that is configurable to set an optical marker for the fiber optic cable 701 that uniquely identifies the fiber optic cable 701, as described above in FIGS. 1-6. In some implementations, the configurable optical marker and the known location of the optical marker device 150 may be used to calibrate the well system 700 for implanting automation in well data collection, as described above in FIGS. 1 and 5.

In some implementations, the well system 700 also may include a fiber optic cable 701. In some implementations, the fiber optic cable 701 may be temporarily deployed (e.g., using a deployment tool) and can be removed from the wellbore 702, as described above in FIGS. 1 and 5. In some implementations, the fiber optic cable 701 may be cemented in place in the annular space between the casing 702 of the wellbore 704 and the subsurface formation 706. In some implementations, the fiber optic cable 701 may be clamped to the outside of the casing 702 during deployment and protected by centralizers and cross coupling clamps. The fiber optic cable 701 may house one or more optical fibers, and the optical fibers may be single mode fibers, multi-mode fibers, or a combination of single mode and multi-mode optical fibers.

In some implementations, the fiber optic cable 701 may be used for distributed sensing where acoustic, strain, and temperature data may be collected. The data may be collected at various positions distributed along the fiber optic cable 701. For example, data may be collected every 1-3 ft along the full length of the fiber optic cable 701. The fiber optic cable 701 may be included with coiled tubing, wireline, loose fiber using coiled tubing, or gravity deployed fiber coils that unwind the fiber as the coils are moved in the wellbore 704. The fiber optic cable 701 also may be deployed with pumped down coils and/or self-propelled containers. Additional deployment options for the fiber optic cable 701 may include coil tubing and wireline deployed coils where the fiber optic cable 701 is anchored at the toe of the wellbore 704. In such embodiments, the fiber optic cable 701 may be deployed when the wireline or coiled tubing is removed from the wellbore 704. The distribution of sensors shown in FIG. 7 is for example purposes only. Any suitable sensor deployment may be used. For example, the well system 700 may include fiber optic cable deployed sensors or sensors cemented into the casing. Different types of sensors deployments also may be combined in a single well, such as including both sensors cemented to the casing and sensors in plugs, flow metering devices, etc. in a single well system.

In some implementations, a fiber optic interrogation unit 712 may be located on the surface 711 of the well system 700. The fiber optic interrogation unit 712 may be directly coupled to the fiber optic cable 701. Alternatively, the fiber optic interrogation unit 712 may be coupled to a fiber stretcher module, wherein the fiber stretcher module is coupled to the fiber optic cable 701. The fiber optic interrogation unit 712 may receive measurement values taken and/or transmitted along the length of the fiber optic cable 701 such as acoustic, temperature, strain, etc. The fiber optic interrogation unit 712 may be electrically connected to a digitizer to convert optically transmitted measurements into digitized measurements. The well system 700 may contain multiple sensors, such as sensors 703A-C. There may be any suitable number of sensors placed at any suitable location in the wellbore 704. The sensors 703A-C may include pressure sensors, distributed fiber optic sensors, point temperature sensors, point acoustic sensors, interferometric sensors or point strain sensors. Distributed fiber optic sensors may be capable of measuring distributed acoustic data, distributed temperature data, and distributed strain data. Any of the sensors 703A-C may be communicatively coupled (not shown) to other components of the well system 700 (e.g., the computer 710). In some implementations, the sensors 703A-C may be cemented to a casing 702.

In some implementations, a computer 710 may receive the electrically transmitted measurements from the fiber optic interrogation unit 712 using a connector 725. The computer 710 may include a signal processor to perform various signal processing operations on signals captured by the fiber optic interrogation unit 712 and/or other components of the well system 700. The computer 710 may have one or more processors and a memory device to analyze the measurements and graphically represent analysis results on the display device 750.

In some implementations, the fiber optic interrogation unit 712 may operate using various sensing principles including but not limited to amplitude-based sensing systems like Distributed Temperature Sensing (DTS), DAS, Distributed Vibration Sensing (DVS), and Distributed Strain Sensing (DSS). For example, the DTS system may be based on Raman and/or Brillouin scattering. A DAS system may be a phase sensing-based system based on interferometric sensing using homodyne or heterodyne techniques where the system may sense phase or intensity changes due to constructive or destructive interference. The DAS system may also be based on Rayleigh scattering and, in particular, coherent Rayleigh scattering. A DSS system may be a strain sensing system using dynamic strain measurements based on interferometric sensors (e.g., sensors 703A-C) or static strain sensing measurements using Brillouin scattering. DAS systems based on Rayleigh scattering may also be used to detect dynamic strain events. Temperature effects may in some cases be subtracted from both static and/or dynamic strain events, and temperature profiles may be measured using Raman based systems and/or Brillouin based systems capable of differentiating between strain and temperature, and/or any other optical and/or electronic temperature sensors, and/or any other optical and/or electronic temperature sensors, and/or estimated thermal events.

In some implementations, the fiber optic interrogation unit 712 may measure changes in optical fiber properties between two points in the optical fiber at any given point, and these two measurement points move along the optical sensing fiber as light travels along the optical fiber. Changes in optical properties may be induced by strain, vibration, acoustic signals and/or temperature as a result of the fluid flow. Phase and intensity based interferometric sensing systems may be sensitive to temperature and mechanical, as well as acoustically induced, vibrations. The fiber optic interrogation unit 712 may capture DAS data in the time domain. One or more components of the well system 700 may convert the DAS data from the time domain to frequency domain data using Fast Fourier Transforms (FFT) and other transforms. For example, wavelet transforms may also be used to generate different representations of the DAS data. Various frequency ranges may be used for different purposes and where low frequency signal changes may be attributed to formation strain changes or fluid movement and other frequency ranges may be indicative of fluid or gas movement. Various filtering techniques may be applied to generate indicators of events related to measuring the flow of fluid.

In some implementations, DAS measurements along the wellbore 704 may be used as an indication of fluid flow through the casing 702 in the wellbore 704. Vibrations and/or acoustic profiles may be recorded and stacked over time, where a simple approach could correlate total energy or recorded signal strength with known flow rates. For example, the fiber optic interrogation unit 712 may measure energy and/or amplitude in multiple frequency bands where changes in select frequency bands may be associated with oil, water and/or gas thus enabling multiphase production profiling along the wellbore 704.

Although example well systems are shown in FIGS. 5 and 7, it is noted, however, that the operations and tools described in FIGS. 1-7 can be used in any type of well system that utilizes a fiber optic cable in the oil and gas industry and other industries. For example, the well systems may be any type of drilling, fracturing, completion, and producing well systems. Well systems may include geothermal wells, injection wells used for water injection or CO2 injection or water alternating gas (WAG) or gas injection, hydrocarbon production wells or any other subsurface well or tubular structure for fluid movement. Similarly, the system described may be used in monitoring wells and used for vertical seismic profiling (VSP) or seismic monitoring, or wells that may be plugged and abandoned where the fiber cable is used for integrity monitoring and leak detection purposes. The applications may include subsea wells with dry tree or wet tree fiber optic installations.

As will be appreciated, aspects of the disclosure may be embodied as a system, method or program code/instructions stored in one or more machine-readable media.

Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently.

While the aspects of the disclosure are described with reference to various implementations and exploitations, it will be understood that these aspects are illustrative and that the scope of the claims is not limited to them. In general, techniques for implementing a configurable optical marker to uniquely identify a fiber optic cable and calibrate the well system as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

As used herein, the term “or” is inclusive unless otherwise explicitly noted. Thus, the phrase “at least one of A, B, or C” is satisfied by any element from the set {A, B, C} or any combination thereof, including multiples of any element.

Furthermore, unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

### EXAMPLE EMBODIMENTS

Example Embodiments can include the following:

Embodiments #1: An optical marker device for a well system, the optical marker device comprising: a fiber optic line configured to couple with a fiber optic cable of the well system; and one or more attenuators coupled with the fiber optic line, the one or more attenuators configurable to set an optical marker that uniquely identifies the fiber optic cable of the well system.

Embodiments #2: The optical marker device of Embodiments #1, further comprising: a human-readable label configured to visually identify the fiber optic cable of the well system.

Embodiments #3: The optical marker device of Embodiments #1, wherein the fiber optic line of the optical marker device is configured to receive an optical signal from the fiber optic cable of the well system, and the one or more attenuators are configured to attenuate the optical signal according to one or more set attenuator configurations that set the optical marker for the fiber optic cable.

Embodiments #4: The optical marker device of Embodiments #3, wherein, based on the one or more set attenuator configurations, one or more attenuated and reflected optical signals are output from the optical marker device that include signal signatures that indicate the optical marker that uniquely identifies the fiber optic cable.

Embodiments #5: The optical marker device of Embodiments #3, wherein the fiber optic line includes two or more fiber optic stub paths, at least one of the two or more fiber optic stub paths includes an attenuator, and the two or more fiber optic stub paths include reflectors.

Embodiments #6: The optical marker device of Embodiments #5, wherein, if the optical marker device includes two or more fiber optic stub paths and two or more attenuators, at least a first fiber optic stub path includes a delay mechanism to delay a first optical signal in the first fiber optic stub path compared to at least a second optical signal in at least a second fiber optic stub path for detection of a first signal signature associated with a reflection of the first optical signal in the first fiber optic stub path and a second signal signature associated with a reflection of the second optical signal in the second fiber optic stub path.

Embodiments #7: The optical marker device of Embodiments #1, wherein the optical marker device is configured to couple to the fiber optic cable of the well system at a known position on the fiber optic cable, and wherein the optical marker and the known position of the optical marker device is used by the well system to determine at least one of: a length of a surface section of the fiber optic cable between surface equipment of the well system and a wellhead, and a deployed fiber length of the fiber optic cable within a wellbore of the well system.

Embodiments #8: The optical marker device of Embodiments #7, wherein the length of the surface section of the fiber optic cable and the deployed fiber length of the fiber optic cable within the wellbore is used by the well system to calibrate the well system and implement automation for well data collection.

Embodiments #9: A well system, comprising: a fiber optic cable; and an optical marker device coupled with the fiber optic cable, the optical marker device configurable to set an optical marker that uniquely identifies the fiber optic cable.

Embodiments #10: The well system of Embodiments #9, wherein the optical marker device includes: a fiber optic line configured to couple with the fiber optic cable; and one or more attenuators coupled with the fiber optic line, the one or more attenuators configurable to set the optical marker that uniquely identifies the fiber optic cable.

Embodiments #11: The well system of Embodiments #10, further comprising: surface equipment configured to transmit an optical signal via the fiber optic cable, wherein the fiber optic line of the optical marker device is configured to receive the optical signal from the fiber optic cable, and the one or more attenuators are configured to attenuate the optical signal according to one or more set attenuator configurations that set the optical marker for the fiber optic cable.

Embodiments #12: The well system of Embodiments #11, further comprising: a fiber optic sensing device configured to: detect one or more attenuated and reflected optical signals that are output by the optical marker device; detect signal signatures of the one or more attenuated and reflected optical signals; and identify the fiber optic cable based on the detected signal signatures of the one or more attenuated and reflected optical signals.

Embodiments #13: The well system of Embodiments #9, further comprising a human-readable label that visually identifies the fiber optic cable, wherein the human-readable label is coupled with the optical marker device or the fiber optic cable.

Embodiments #14: The well system of Embodiments #9, wherein the optical marker device is coupled with the fiber optic cable at a known location on the fiber optic cable, further comprising: a fiber data collection system configured to: calibrate the well system based on the optical marker and the known location of the optical marker device; and implement automation for well data collection based on the calibration.

Embodiments #15: The well system of Embodiments #14, wherein the fiber data collection system configured to calibrate the well system includes the fiber data collection system configured to determine, based on the optical marker and the known location of the optical marker device, at least one of: a length of a surface section of the fiber optic cable between surface equipment of the well system and a wellhead, and a deployed fiber length of the fiber optic cable within a wellbore of the well system.

Embodiments #16: The well system of Embodiments #15, wherein, after calibration of the well system, the fiber data collection system is configured to automatically perform data collection from the well, the data collection including at least one or more of microseismic event data collection and strain event data collection, further comprising: a supervisory control system configured to: automatically infer at least one of formation properties and fracture properties related to hydraulic fracturing operations based on the data collection form the well; and automatically control fracturing spread pumps based on the at least one of the formation properties and the fracture properties.

Embodiments #17: A method for implementing a configurable optical marker for a fiber optic cable of a well system, comprising: coupling an optical marker device to the fiber optic cable at a known location on the fiber optic cable; and setting, using the optical marker device, the configurable optical marker that uniquely identifies the fiber optic cable of the well system.

Embodiments #18: The method of Embodiments #17, wherein setting, using the optical marker device, the configurable optical marker that uniquely identifies the fiber optic cable includes configuring the optical marker device to set the configurable optical marker for the fiber optic cable, and wherein configuring the optical marker device to set the configurable optical marker includes configuring one or more attenuators of the optical marker device to set the configurable optical marker.

Embodiments #19: The method of Embodiments #17, further comprising: setting a human-readable label configured to visually identify the fiber optic cable of the well system; and storing an association between the configurable optical marker, the human-readable label, and the fiber optic cable in a database.

Embodiments #20: The method of Embodiments #17, further comprising: transmitting an optical signal via the fiber optic cable of the well system; detect one or more attenuated and reflected optical signals that are output by the optical marker device; determine the configurable optical marker from the one or more attenuated and reflected optical signals;
and identify the fiber optic cable based on the configurable optical marker determined from the one or more attenuated and reflected optical signals.

What is claimed is:

1. An optical marker device for a well system, the optical marker device comprising:
a fiber optic line configured to couple with a fiber optic cable of the well system; and
one or more attenuators coupled with the fiber optic line, the one or more attenuators configurable to set an optical marker that uniquely identifies the fiber optic cable of the well system.

2. The optical marker device of claim 1, further comprising:
a human-readable label configured to visually identify the fiber optic cable of the well system.

3. The optical marker device of claim 1, wherein the fiber optic line of the optical marker device is configured to receive an optical signal from the fiber optic cable of the well system, and the one or more attenuators are configured to attenuate the optical signal according to one or more set attenuator configurations that set the optical marker for the fiber optic cable.

4. The optical marker device of claim 3, wherein, based on the one or more set attenuator configurations, one or more attenuated and reflected optical signals are output from the optical marker device that include signal signatures that indicate the optical marker that uniquely identifies the fiber optic cable.

5. The optical marker device of claim 3, wherein the fiber optic line includes two or more fiber optic stub paths, at least one of the two or more fiber optic stub paths includes an attenuator, and the two or more fiber optic stub paths include reflectors.

6. The optical marker device of claim 5, wherein, if the optical marker device includes two or more fiber optic stub paths and two or more attenuators, at least a first fiber optic stub path includes a delay mechanism to delay a first optical signal in the first fiber optic stub path compared to at least a second optical signal in at least a second fiber optic stub path for detection of a first signal signature associated with a reflection of the first optical signal in the first fiber optic stub path and a second signal signature associated with a reflection of the second optical signal in the second fiber optic stub path.

7. The optical marker device of claim 1, wherein the optical marker device is configured to couple to the fiber optic cable of the well system at a known position on the fiber optic cable, and wherein the optical marker and the known position of the optical marker device is used by the well system to determine at least one of:
a length of a surface section of the fiber optic cable between surface equipment of the well system and a wellhead, and
a deployed fiber length of the fiber optic cable within a wellbore of the well system.

8. The optical marker device of claim 7, wherein the length of the surface section of the fiber optic cable and the deployed fiber length of the fiber optic cable within the wellbore is used by the well system to calibrate the well system and implement automation for well data collection.

9. A well system, comprising:
a fiber optic cable; and
an optical marker device coupled with the fiber optic cable, the optical marker device configurable to set an optical marker that uniquely identifies the fiber optic cable.

10. The well system of claim 9, wherein the optical marker device includes:
a fiber optic line configured to couple with the fiber optic cable; and
one or more attenuators coupled with the fiber optic line, the one or more attenuators configurable to set the optical marker that uniquely identifies the fiber optic cable.

11. The well system of claim 10, further comprising:
surface equipment configured to transmit an optical signal via the fiber optic cable, wherein the fiber optic line of the optical marker device is configured to receive the optical signal from the fiber optic cable, and the one or more attenuators are configured to attenuate the optical signal according to one or more set attenuator configurations that set the optical marker for the fiber optic cable.

12. The well system of claim 11, further comprising:
a fiber optic sensing device configured to:
detect one or more attenuated and reflected optical signals that are output by the optical marker device;
detect signal signatures of the one or more attenuated and reflected optical signals; and
identify the fiber optic cable based on the detected signal signatures of the one or more attenuated and reflected optical signals.

13. The well system of claim 9, further comprising a human-readable label that visually identifies the fiber optic cable, wherein the human-readable label is coupled with the optical marker device or the fiber optic cable.

14. The well system of claim 9, wherein the optical marker device is coupled with the fiber optic cable at a known location on the fiber optic cable, further comprising:
a fiber data collection system configured to:
calibrate the well system based on the optical marker and the known location of the optical marker device; and
implement automation for well data collection based on the calibration.

15. The well system of claim 14, wherein the fiber data collection system configured to calibrate the well system includes the fiber data collection system configured to determine, based on the optical marker and the known location of the optical marker device, at least one of:
a length of a surface section of the fiber optic cable between surface equipment of the well system and a wellhead, and
a deployed fiber length of the fiber optic cable within a wellbore of the well system.

16. The well system of claim 15, wherein, after calibration of the well system, the fiber data collection system is configured to automatically perform data collection from the well, the data collection including at least one of microseismic event data collection and strain event data collection, further comprising:
a supervisory control system configured to:
automatically infer at least one of formation properties and fracture properties related to hydraulic fracturing operations based on the data collection form the well; and
automatically control fracturing spread pumps based on the at least one of the formation properties and the fracture properties.

17. A method for implementing a configurable optical marker for a fiber optic cable of a well system, comprising:
coupling an optical marker device to the fiber optic cable at a known location on the fiber optic cable; and
setting, using the optical marker device, the configurable optical marker that uniquely identifies the fiber optic cable of the well system.

18. The method of claim 17, wherein setting, using the optical marker device, the configurable optical marker that uniquely identifies the fiber optic cable includes configuring the optical marker device to set the configurable optical marker for the fiber optic cable, and wherein configuring the optical marker device to set the configurable optical marker includes configuring one or more attenuators of the optical marker device to set the configurable optical marker.

19. The method of claim 17, further comprising:
setting a human-readable label configured to visually identify the fiber optic cable of the well system; and
storing an association between the configurable optical marker, the human-readable label, and the fiber optic cable in a database.

20. The method of claim 17, further comprising:
transmitting an optical signal via the fiber optic cable of the well system;
detect one or more attenuated and reflected optical signals that are output by the optical marker device;
determine the configurable optical marker from the one or more attenuated and reflected optical signals; and
identify the fiber optic cable based on the configurable optical marker determined from the one or more attenuated and reflected optical signals.
